(19) United States
(12) Patent Application Publication
(10) Pub. No.: US 2014/0250672 A1
(43) Pub. Date: Sep. 11, 2014

(54) BASEBALL AND SOFTBALL EQUIPMENT ORGANIZER

(71) Applicant: Louis White, Inver Grove Heights, MN (US)

(72) Inventor: Louis White, Inver Grove Heights, MN (US)

(21) Appl. No.: 14/200,799

(22) Filed: Mar. 7, 2014

Related U.S. Application Data
(60) Provisional application No. 61/773,922, filed on Mar. 7, 2013.

(51) Int. Cl. A63B 71/00; F16M 13/02

(52) U.S. Cl. CPC A63B 71/0045; F16M 13/022
USPC 29/525.08; 248/290.1

(57) ABSTRACT

A baseball and softball equipment organizer includes a base with front and back surfaces, at least one hingable element attached to the front surface of the base with at least one arm rotatably coupled to the hingable element and at least one hook attached to the back surface of the base for removable attachment of the organizer to a chain link fence. The at least one arm can rotate from a first position generally parallel to the base to a second position generally orthogonal to the base. The outside surface of at least one arm can include a gripping material to organize batting gloves and other sports items. A method of using the organizer is described.

### CLAIM OF PRIORITY

This patent application claims the benefit of priority under 35 U.S.C. §119(e) of White, U.S. Provisional Patent Application Ser. No. 61/773,922 entitled “Baseball and Softball Equipment Organizer,” filed on Mar. 7, 2013, which is hereby incorporated by reference herein in its entirety.

### BACKGROUND

This organizer relates to the field of organizing baseball and softball player bats. More specifically, the organizer comprises the placement and storage of bats and sometimes helmets of the baseball player during a ball game being played.

There are known devices for a Bat Rack. Most of these are a hard, fixed, and usually bulky in nature to hang multiple baseball bats and sometimes batting helmets. One good example is the permanent fixed, metal, multiple bat rack, which is traditionally mounted in one spot in the team's bench area and is shared by all the team members during a ball game being played.

These devices usually result in the bats and helmets getting piled on top of one another, lying on the ground and creates a very cluttered area that causes a hazard area and becomes a danger of a ball player injuring themselves.

### OVERVIEW

The present device comprises the ball players personal baseball equipment organizing and storing device that will attach to a chain link fence. The device consists of a solid base with two base attachment hooks fixed to the back side of the device spaced equally apart attaching the device to any one of the diamond patterns of a chain link fence. This gives each team member the ability to store their personal baseball equipment; a bat, a ball glove, a hat, and a pair of batting gloves, by rotating the organizing arms with gripping material that is attached to the base by two pivot mounts, in the down position 90 degrees, until the arms come to rest on the built in stops that are created by two slot openings placed in the device base.

The ball player has the capability to place the device anywhere in the bench area, or where the ball player chooses to place the device on any diamond pattern of a chain link fence of the baseball field, the device can be easily removed from the chain link fence and with the arms rotated 90 degrees in the up position, the device becomes compact for easy storing and portability when no longer in use.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view, showing the front side of the present invention.

FIG. 2 is a perspective view, showing the back side with attachment hooks for mounting of the present invention.

FIG. 3 is a side view, showing the present inventions organizing arms rotated down 90 degrees in the extended position for placement and storage of the ball player equipment.

FIG. 4 is a side view, showing the present inventions organizing arms rotated 90 degrees in the up position for compact storage when not in use.

### DETAILED DESCRIPTION

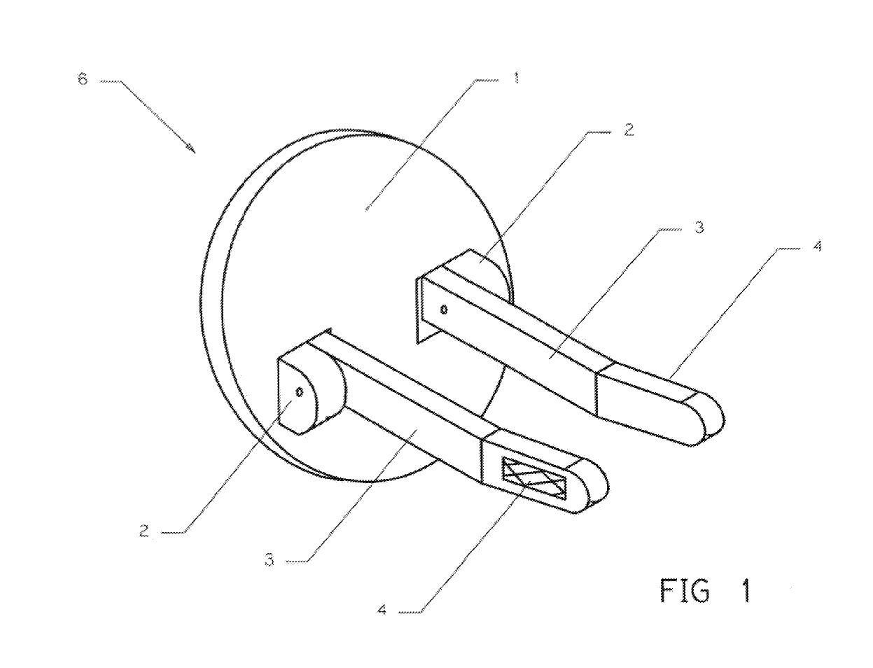

FIG. 1 shows a perspective front view of the present invention 6, in an assembled state. The baseball and softball equipment organizer device 6, includes a base 1, pivot mounts 2, organizing arms 3 and gripping material 4, which make up the various components of the device. The device is configured to be attached anywhere along the chain link fence of the baseball or softball playing field, but typically in the ball team bench area.

The base 1 has two pivot mounts 2, attached to the base 1 to provide the 90 degree pivoting rotation point for the organizing arms 3, shown in the extended position. The pivoting organizing arms 3, when extended, provides placement and storage for the individual baseball player's equipment, baseball or softball bat, one or a pair of batting gloves, the baseball glove, and a baseball cap. This can be achieved by placing the device on the chain link fence in the area of the team member's choice, then physically pivoting the organizing arms 3, 90 degrees in the down (horizontal) position for the team member's equipment placement for use during a ball game. The gripping material 4, is fixed on the outside surface of the organizing arms 3, for the attachment of the players batting gloves. When finished using the device and the player's equipment is removed, rotate the organizing arms 3, 90 degrees up, (vertical) position and remove from the chain link fence for easy storage.

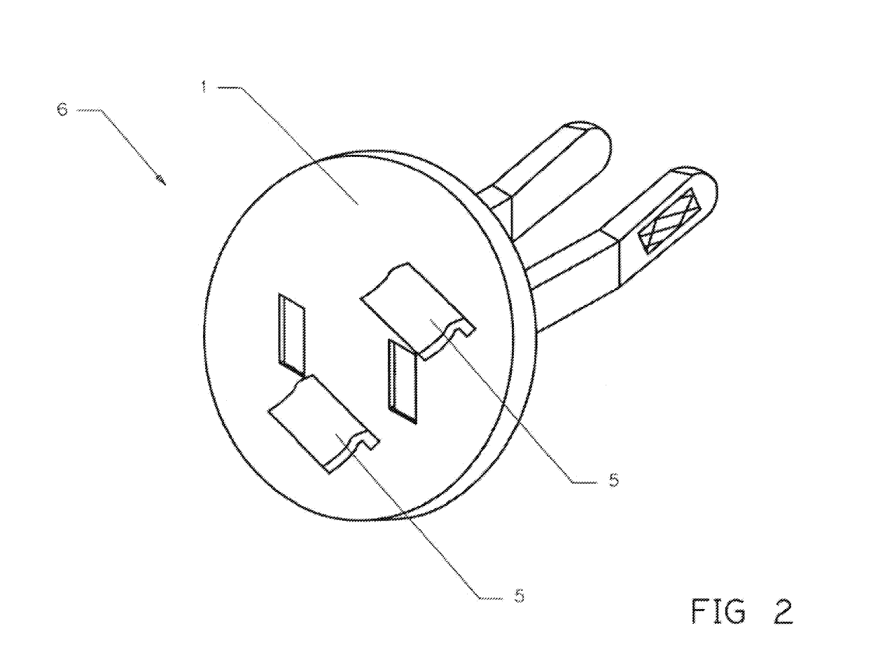

FIG. 2 shows a perspective rear view of the present invention 6, in an assembled state. The hooks 5 are fixed on the back side of the base 1 which allows the user of the present invention to attach the device to a chain link fence in any area of the ball players choice for use during the ball game, with the ability to detach the present invention from the chain link fence when finished using the device for easy storage until the next use.

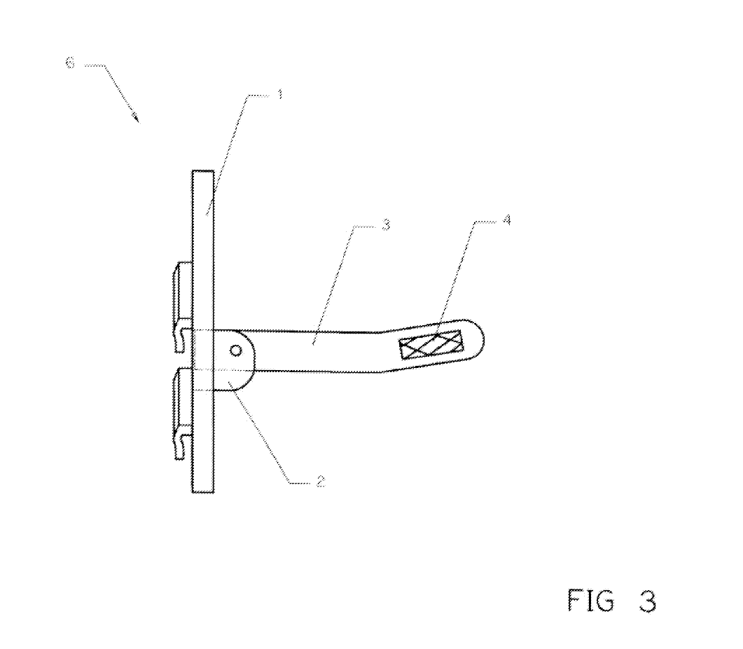

FIG. 3 shows the side view of the present invention 6, this view shows the base 1, with the pivot mounts 2 attached, and the organizing arms 3 attached to the pivot mounts 2 rotated down 90 degrees (horizontal) in its extended position for use once the device is attached to a chain link fence in an area of the ball players choice. The organizing arms 3, has the gripping material 4, fixed to the outside surface of each arm providing the placement for attaching the ball players batting gloves. The organizing arms 3, also provide the placement and storage of the ball player's bat, the ball player's baseball glove, and ball cap.

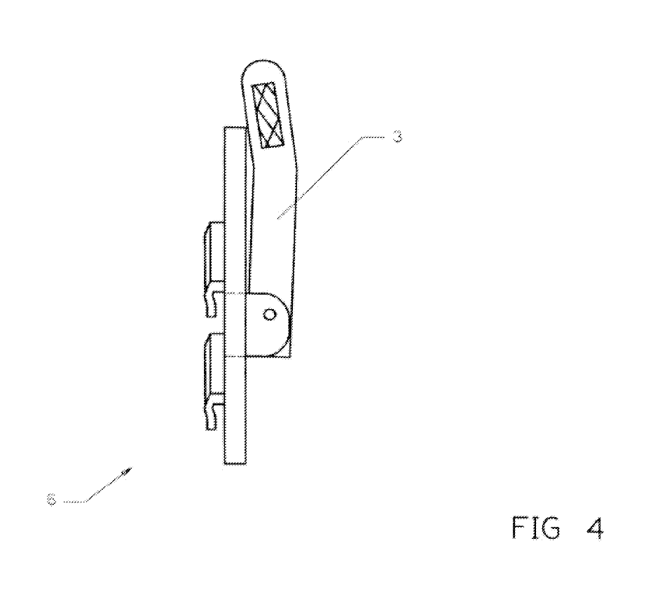

FIG. 4 shows the side view of the present invention 6, this view shows the organizing arms 3, rotated up (vertical) in its retracted position when not in use, this makes the device easy to detach from the chain link fence and also makes the device compact for easy storage.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A sport equipment organizing device comprising:
a base with a front surface and a back surface;
at least one rotatable element attached to the front surface of the base and connected to a first arm and a second arm, the first and second arms configured for releasably storing a baseball bat; and
at least one hook attached to the back surface, wherein the at least one hook is configured to removably attach the base to a chain link fence.

2. The device of claim 1 wherein the at least one rotatable element includes a first rotatable element connected to the first arm and a second rotatable element connected to the second arm.

3. The device of claim 1 wherein a gripping material is attached to an outside surface of at least one of the first arm and the second arm.

4. The device of claim 1 wherein the at least one hook includes two hooks attached to the back surface.

5. The device of claim 4 wherein the two hooks are located along an axis at an angle of approximately 45 degrees from a horizontal axis where the horizontal axis is a line passing through the centers of the first rotatable element and the second rotatable element.

6. The device of claim 5 wherein the hooks are generally downward facing when attached to a chain link fence.

7. The device of claim 1 wherein the at least one rotatable element is movable from a first position generally parallel to the front surface to a second position that is generally orthogonal to the front surface.

8. A sports equipment organizing device comprising:
a base with a front surface and a back surface;
a first arm and a second arm configured for releasably storing a baseball bat, each arm rotatably coupled to the front surface such that the first and second arms are rotatable relative to the base; and
a first hook and a second hook, each hook attached to the back surface, wherein the first and second hooks are configured to removably attach the base to a chain link fence.

9. The device of claim 8 wherein a gripping material is attached to an outside surface of at least one of the first arm and the second arm.

10. The device of claim 9 wherein the gripping material is configured for releasably storing batting gloves or other personal baseball equipment.

11. The device of claim 8 wherein the first and second hooks are located along an azimuthally inclined axis at an angle of approximately 45 degrees from a horizontal axis where the horizontal axis is a line passing through the centers of the first rotatable element and the second rotatable element.

12. The device of claim 8 wherein each of the first and second hooks removably engages a portion of a diamond-shaped structure of the chain link fence.

13. The device of claim 8 wherein each of the first and second arms is movable from a first position generally parallel to the front surface to a second position generally orthogonal to the front surface.

14. The device of claim 13 wherein the first position is a stowed position and the second position is configured to store a baseball bat.

15. A method of using a sports equipment organizing device to organize sports equipment, the method comprising:
providing a device comprising:
a base with a front surface and a back surface;
at least one rotatable element attached to the front surface and connected to a first arm and a second arm, the first and second arms configured for releasably storing a baseball bat; and
at least one hook attached to the back surface;
locating an appropriate portion of chain link fence;
placing the back surface of the device substantially against the chain link fence so that the at least one hook removably engages a portion of a diamond-shaped structure in the chain link fence; and
storing the baseball bat between the first and second arms.

16. The method of claim 15 further comprising:
storing personal baseball equipment by hanging the equipment from gripping material on an outside surface of at least one of the first and second arms.

17. The method of claim 15 wherein the first and second arms are movable from a first position to a second position after the device is attached to the fence and prior to storing the baseball bat, the first position being generally parallel to the front surface and the second position being generally orthogonal to the front surface.
